(19) United States
(12) Patent Application Publication
(10) Pub. No.: US 2016/0066536 A1
(43) Pub. Date: Mar. 10, 2016

(54) Fencing Rail

(71) Applicant: Think Fencing Pty Ltd, Portarlington (AU)

(72) Inventors: Jack Leighton Fitzgerald, Portarlington (AU); Louis Thomas Ross Fitzgerald, Portarlington (AU)

(21) Appl. No.: 14/845,377

(22) Filed: Sep. 4, 2015

(30) Foreign Application Priority Data
Sep. 8, 2014 (AU) 2014903555

(51) Int. Cl. A01K 3/00; E04H 17/14

(52) U.S. Cl. CPC A01K 3/005; E04H 17/1417

(57) ABSTRACT

A fencing rail 10, including an elongate hollow plastic extrusion, which is generally rectangular in cross-section and which has an outer surface 13. The fencing rail 10 further includes an elongate, electrically conductive member 20, 21, which is attached adjacent to the outer surface 13 of the extrusion by a conductive medium 22 which overlies the conductive member 20, 21.

### FIELD OF THE INVENTION

The present invention relates to rails which are used in fencing installations for fencing livestock such as horses, cows, sheep etc. The present invention principally relates to electrified fencing rails that are oriented in use as horizontal rails, although it can also apply to vertical rails or rails disposed other than horizontally or vertically.

### BACKGROUND OF THE INVENTION

The following discussion of the background to the invention is intended to facilitate an understanding of the invention. However, it should be appreciated that the discussion is not an acknowledgement or admission that any of the material referred to was published, known or part of the common general knowledge as at the priority date of the application.

Livestock is generally fenced in paddocks to control the location of the livestock for various purposes, such as to control feeding, to separate some livestock from others, to assemble livestock for transport, vaccination or other treatment. The fencing needs to be robust for longevity and thus needs to resist the effects of weather and contact by livestock. In respect of livestock contact, livestock fencing is sometimes electrified so that the livestock will receive a high voltage but low amperage electric shock upon contact with the fencing. The livestock tends to immediately move away from the fencing upon receiving a shock so that further contact with the fencing is avoided, while over time, livestock develop a memory of the electric shock and tend to avoid contact with the fencing.

The present invention has been developed principally for fencing for horses, in studs, racing tracks, parade grounds etc., and so further discussion will be made in relation to that aspect of the invention. However, it should be appreciated that the invention can apply to fencing for other purposes such as for other animals.

Electric fencing for fencing horses is used to limit damage to fencing by horses and to avoid injury to the horses. In respect of damage to the fencing, horses can bear on the fencing to reach feed on the other side of the fence or to engage with horses on the other side, they can run into the fencing as they are running within a paddock and they can catch equipment, such as reins or rugs on the fencing. All of that contact can damage the fence and equipment and can also injure the horse.

Accordingly, electric fencing has been used in the past to minimise contact between fencing and horses. Advantageously, horses appear to learn to avoid contact with electric fences after only a small number of fence contacts and thereafter, damage to the fencing and injury to horses is eliminated or minimised.

Nevertheless, the electric fences currently known to applicant still suffer damage with even the reduced contact between the horses and the fencing. Accordingly, the applicant considers that improved electric fencing is desirable, in particular that is more robust than other forms of prior art electric fencing.

### SUMMARY OF THE INVENTION

The present invention provides a fencing rail formed from an elongate hollow plastic extrusion, which is generally rectangular in cross-section. The plastic extrusion has an outer surface and the fencing rail further includes an elongate, electrically conductive member which is attached adjacent to the outer surface of the extrusion by a conductive medium which overlies the conductive member. The present invention therefore provides an electric or electrified fencing rail.

A fencing rail according to the present invention advantageously is formed at least substantially of plastic, which makes the fencing rail relatively light weight and depending on the plastic selected, robust. A plastic fencing rail can have properties which enable it to outlive prior art rails of other material such as timber. Moreover, the use of a plastic material enables the fencing rail to be readily formed and worked on site as a plastic material is readily or easily cut and drilled. It will be appreciated that the use of plastic for the fencing rail of the invention means that the fencing rail will not rot like timber rails, and will not rust like metal rails.

A fencing rail according to the present invention is formed from a plastic extrusion that is hollow. Thus, the rail can be formed to be very rigid but lightweight. The rail can be formed to be flexible to the extent necessary to absorb the impact of contact with fenced animals such as horses and to securely maintain the horses fenced. This can be achieved by suitable selection of plastic material and/or suitable selection of the cross-section of the extrusion.

The electrically conductive member can take any suitable form. For example, the member can be a conductive plastic or metal wire, such as an aluminium wire. Alternatively, the wire can be copper or steel. The member could alternatively be a conductive strip, such as a flat strip that is square or rectangular in cross-section. The flat strip could be metallic, such as aluminium, copper or steel, or it could be a conductive plastic. Still alternatively, the electrically conductive member can be a conductive thread or tape. The conductive member can be flexible but if required, stiff. Clearly many forms of conductive material could be employed for the electrically conductive member.

The conductive medium can take any suitable form. The medium needs to attach the conductive member to the outer surface of the plastic extrusion and to overlie the conductive member. The conductive member is thus not exposed once the conductive medium has been applied, although small areas of exposure can be tolerated if the covering is disturbed by animal contact for example. The conductive member is therefore substantially or fully covered or enveloped by the conductive medium. The conductive medium is also the means by which the conductive member is attached to the outer surface of the plastic extrusion and the requirement for conductivity is because the medium overlies the conductive medium so that when an animal comes into contact with the fencing rail of the invention, the current in the conductive member needs to transfer through the medium to shock the animal. The conductive medium also assists to protect the conductive member against rust or corrosion and damage through animal contact.

The conductive medium can be a conductive strip or tape that is applied over the conductive member and which adheres to the outer surface of the plastic extrusion. The strip or tape can be adhesive, or an adhesive can be applied separately between the strip or tape and the outer surface of the plastic extrusion. Alternatively, the conductive medium can be a pressure sensitive adhesive material which can be malleable. This type of conductive material can take the form of a gel, putty, plaster, or paste. The material can harden once applied and the hardening can take place over time, ie not necessarily immediately.

The conductive medium can completely encase or enclose the conductive member. Thus, the conductive member can be spaced from the outer surface of the plastic extrusion by a layer of conductive medium that is interposed between the member and the outer surface. Forms of medium that can be applied in this manner include the malleable forms of medium discussed above. Alternatively, the conductive medium can partially encase or enclose the conductive member, so that the member is in touching or bearing contact or engagement with the outer surface of the plastic extrusion. Forms of medium that can be applied in this manner include the strip or tape forms of medium discussed above. In some forms of the invention, the conductive member is spaced from the outer surface of the plastic extrusion at some points along the fencing rail and is in touching or bearing contact or engagement with the outer surface of the plastic extrusion at other points. This can occur because of the simple or rudimentary manner in which the conductive medium is applied to the plastic extrusion at least at present, in which the conductive medium is a putty or paste and is pressed into place over and about the conductive member. The conductive member therefore can vary in spacing from the outer surface of the plastic extrusion, so that it is in contact with the outer surface at some points and is spaced from the outer surface at other points. This can be tolerated because there is no requirement or disadvantage associated with having the conductive member either spaced from, or in touching or bearing contact or engagement with the outer surface of the plastic extrusion.

The conductive medium can be selected from ASA (Acrylonitrile Styrene Acrylate), acrylic, polyolefin, polyvinyl chloride (PVC), thermos-setting polymer, polyurethane, epoxy, polyester, which have a high carbon content to promote conductivity. Other polymer mediums could also be used. These can include conductive particles for conduction, such as stainless steel particles including nano particles. Other forms of conductive medium could be employed, in particular new forms of conductive medium that will be developed in the future.

The conductive member can be positioned on the outer surface of the plastic extrusion at any suitable position. The plastic extrusion is generally rectangular in cross-section and therefore will have a pair of generally parallel long sides and a pair of generally parallel short ends and a suitable position can be along one of the long sides between the short ends. In use, the rail will normally be positioned with the long sides extending generally vertically, although the orientation of the rail can be selected as appropriate. A conductive member can be applied to each of the opposite long sides where animals are to be located on each side of the fencing rail. More than one conductive member can be applied to each side.

In some forms of the invention, the conductive member is applied at the upper junction or corner between a long side and a short end. This is advantageous because it is the position of the fencing rail which is likely to receive animal contact over different forms of contact that can be made. For example, a horse that reaches over a fencing rail is likely to contact the top of the rail including the junction or corner between a long side and a short end. Also, a horse that glances the fencing rail as it moves along the rail will also likely contact the rail at the junction or corner. However, as indicated above, two or more conductive members can be applied to the outer surface of the plastic extrusion to improve the likelihood of animal engagement with the conductive medium that overlies the conductive members.

The plastic extrusion of the fencing rail according to the invention is likely to be formed from a PVC composite, although other plastics can be employed. For example, the plastic extrusion could be formed from any one of the following: PVC(Poly Vinyl Chloride), ASA (Acrylonitrile Styrene Acrylate), ABS (Acrylonitrile Butadiene Styrene), PMMA (Poly Methyl Methacrylate), HIPS (High Impact Styrene), PC (Poly Carbonate), PP (Polypropylene), PE (Polyethylene), Nylon, WPC (Wood Plastic Composite), SAN (Styrene and Acrylonitrile).

The fencing rail is generally rectangular in cross-section and in some arrangements of the invention, the height of the fencing rail is about three times the width. However, the fencing rail can be of any generally rectangular dimensions and could for example have a height which is about twice the width, or alternatively about four times the width.

The wall thickness of the plastic extrusion can be of any suitable thickness, but in some forms of the invention, the wall thickness is between 1 mm and 4 mm, or between 2 mm and 3 mm, or is about 2 mm. The thickness of the wall of the plastic extrusion can affect the strength and stiffness of the fencing rail, although, as will be described later herein, the use of strengthening ribs and webs can be employed to impart strength and stiffness without needing to increase the wall thickness or to employ a stronger or stiffer plastic material.

A fencing rail according to some forms of the invention can include a thin substrate which is applied to the outer surface of the extrusion, and in some forms substantially the full outer surface, to form an outer skin. Such a thin substrate can be applied to the outer surface to enable the fencing rail to be coloured and/or textured to suit the particular fence installation being constructed. Thus, for example, the outer substrate could have a timber look, so that the fencing rail of the invention appears to have a traditional timber appearance. Alternatively, the fencing rail could have the look of a metal fencing rail, or it could be coloured in a variety of different colours for selection by the consumer. The application of a coloured substrate overcomes a drawback with the use of polyvinylchloride (PVC) which is difficult to paint in a manner in which the paint has a long life. Typically, PVC is not painted as the paint does not normally last very long so the aesthetic appeal of PVC is not high.

The substrate can additionally be UV stabilised and can have other properties such as for weather protection and scratch resistance, while flame retardants can be included to make the fencing rail self-extinguishing. This is important for electrified fencing to which the present invention applies.

The substrate which is applied to the outer surface of the extrusion to form an outer layer or skin can be made of any suitable material, although in some forms of the invention, the substrate is formed from ASA (Acrylonitrile Styrene Acrylate), ABS (Acrylonitrile Butadiene Styrene), PMMA (Poly Methyl Methacrylate) Nylon, SAN (Styrene and Acrylonitrile) or Polycarbonate. The substrate can have a thickness of about 0.5>1.0 mm.

Application of the substrate to the outer surface of the extrusion can be achieved in any suitable manner such as by stretching the substrate about the extrusion and allowing the substrate to shrink into firm and close contact with the outer surface. Heat can be used to assist the shrinking process or the material of the substrate and its dimensions can be selected so that the substrate naturally shrinks about the plastic extrusion.

Alternatively, the substrate can be adhered to the outer surface of the extrusion by any suitable adhesive.

In one form of the invention, application of the substrate to the outer surface of the extrusion can also be completed in a single process called “co-extrusion” whereby two or more extruders force molten polymer into a single die and the polymer is diverted into cavities in the die that regulate the flow and placement into the crude shape of the composite fencing rail (“composite” meaning the combination of the plastic extrusion and substrate). The composite fencing rail then enters a forming/cooling calibration chamber, in which vacuum and pressure are used to form the polymer into the final shape of the fencing rail. In this co-extrusion process, continuous production of a fencing rail according to the invention can take place, with the continuous rail being separated into sections once it exits the die and is sufficiently rigid for engagement by a suitable guillotine or saw.

As indicated earlier, a fencing rail according to the invention can include webs or ribs for stiffening and strengthening purposes. In some forms of the invention, the plastic extrusion has a pair of generally parallel long sides and a pair of generally parallel short ends which define the generally rectangular cross-section of the fencing rail and which define an interior between the sides and ends. In that construction, the plastic extrusion can include a web extending across the interior from one of the pair of long sides to the other of the pair of long sides. The web can be formed integrally as part of the plastic extrusion.

The web described above can extend substantially parallel to the short ends and can separate the interior into a pair of chambers on either side of the web which can be of substantially the same or different dimensions.

Alternatively, the fencing rail can include more than a single web and for example, can include a pair of webs which extend across the interior of the plastic extrusion from one of the pair of long sides to the other of the pair of long sides, with the webs being spaced apart from each other.

Where a pair of webs is provided, those webs can both be substantially parallel to the short ends of the plastic extrusion and the pair of webs can separate the interior into three chambers. The chambers can be of equal size or volume or can be of different size or volume.

Additional webs or ribs can be provided as required, so that in other forms of the invention, three or more webs can be provided bridging the interior of the plastic extrusion between the pair of long sides.

The extrusions can be prefabricated to particular lengths and can include textured surfaces and openings or slots for the receipt of screw fasteners, or other components for the purpose of forming an electrified fence.

### BRIEF DESCRIPTION OF THE DRAWINGS

In order that the invention may be more fully understood, some embodiments will now be described with reference to the figures in which:

FIG. 1 illustrates in perspective view a fencing rail according to the invention.

FIG. 2 is a cross-sectional view of a fencing rail according to the invention.

FIG. 3 is a cross-sectional view of an alternative fencing rail according to the invention.

FIG. 4 is a cross-sectional view of a further alternative fencing rail according to the invention.

### DETAILED DESCRIPTION OF THE DRAWINGS

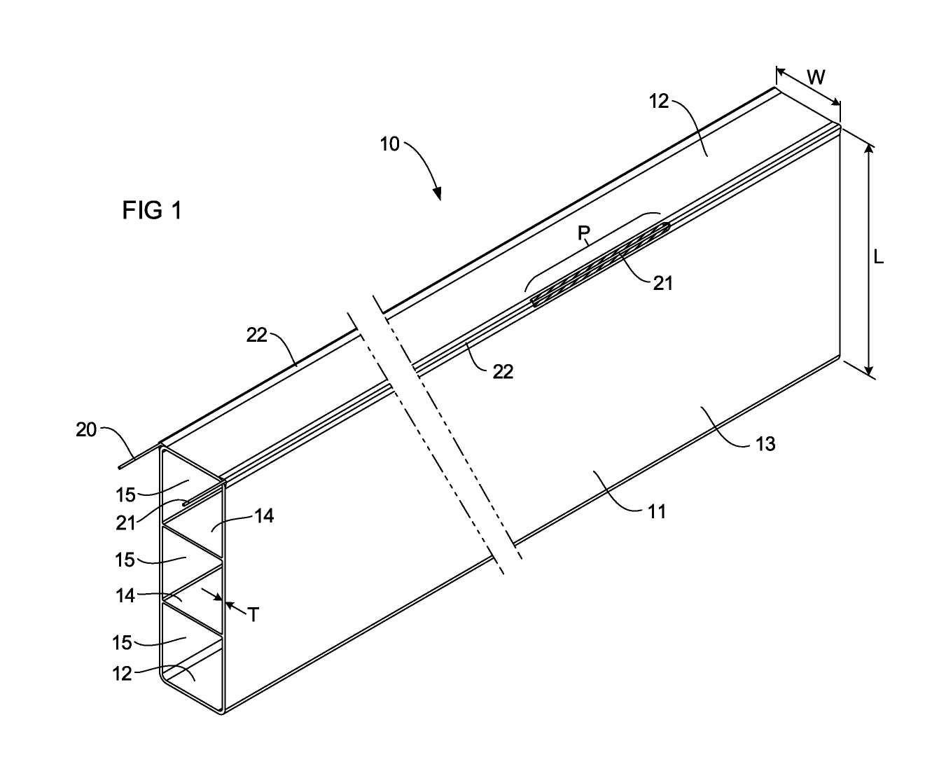

FIG. 1 illustrates a portion of a fencing rail 10 according to the invention. The fencing rail 10 is formed to have a generally rectangular cross-section, defined by a pair of generally parallel long sides 11 and a pair of generally parallel short ends 12. The fencing rail 10 can be formed to any length that is required and can include openings, notches and other fabricated additions for the purposes of installing the fencing rail. The portion of the fencing rail 10 is shown as it would normally be oriented in the field, with the long sides 11 extending substantially vertically.

In the form of fencing rail illustrated in FIG. 1, the length L of the cross-section is approximately three times the width W. As indicated earlier, other relative dimensions of the cross-sectional shape of the fencing rail 10 can be adopted.

The wall thickness T can be in the region of from 1 mm to 4 mm, although in the arrangement illustrated, the preference is for the thickness T to be about 2 mm.

The fencing rail 10 is formed from a plastic extrusion such as PVC or the other materials discussed above. A thin substrate such as ASA or the other materials discussed above, can be applied to or over the outer surface 13 of the extrusion for the purposes described above.

The fencing rail 10 includes ribs or webs 14 which extend substantially parallel to each other and substantially parallel to the short ends 12 between the long sides 11. The webs 14 are formed as part of the extrusion process of the plastic extrusion and are formed integrally with the long sides 11. The webs 14 separate the interior of the fencing rail 10 into three equal chambers 15.

The fencing rail 10 further includes a pair of electrically conductive members 20 and 21 which extend lengthwise of the fencing rail 10 at the corner or junction between the long sides 11 and the short sides 12. Each of the conductive members 20 and 21 is attached adjacent to the outer surface 13 of the fencing rail 10 by a conductive medium 22, which overlies or envelopes each of the conductive members 20 and 21. In FIG. 1, a portion P of the medium 22 that overlies the conductive member 21 is shown broken away, so the member 21 can be seen extending within the medium 22.

The conductive members 20 and 21 are shown in the form of a metal wire, such as aluminium, copper or steel wire. As discussed earlier, alternative forms of conductive members can be employed and those alternative forms could be employed in the FIG. 1 embodiment.

The conductive medium 22 adheres the members 20 and 21 to the outer surface 13 of the fencing rail 10. Thus, the conductive medium 22 is an adhesive medium, as well as being conductive. FIG. 1 shows the conductive medium 22 as being of uniform cross section throughout the length of the fencing rail 10, but in practice, this might not be and is probably unlikely to be the case. For example, in some forms of the invention, both the conductive members 20 and 21 and the conductive medium 22 will be applied by hand, with the conductive medium being a malleable medium which is pushed into place by finger pressure. In those forms of the invention, the conductive medium will be non-uniform along the length of the fencing rail 10, but will nevertheless attach the members 20 and 21 to the outer surface 13 of the rail 10 in a manner in which the conductive 20 and 21 are fully enclosed or encased by the medium 22. Mechanical application of the conductive medium 22 to the outer surface 13 will likely produce a more uniform cross-section of the conductive medium.

It is further to be appreciated that the use of two conductive members 20 and 21 illustrates that multiple conductive members can be employed in a fencing rail according to the invention. Indeed, further conductive members could be attached by a suitable conductive medium to the long sides 11 of the rail 10, rather than being positioned at the junction between the sides 11 and the ends 12.

The conductive medium 22 has been discussed above as being a malleable medium, but it equally could be provided in an adhesive tape or strip form, which can be rolled from a reel. The strip or tape can be of any suitable fabric, or polymer material or other suitable material which can attach the conductive members 20 and 21 to the outer surface 13 of the fencing rail 10 and allow current to transfer through the medium.

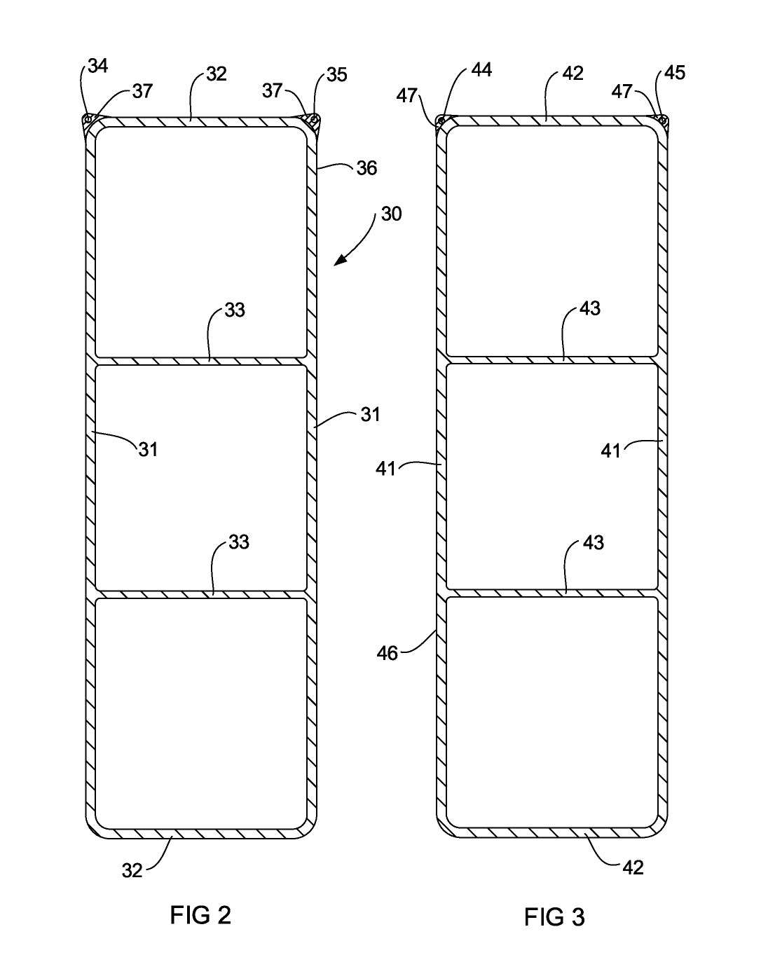

FIGS. 2 and 3 illustrate very similar arrangements to the fencing rail 10, but with slight differences as will become apparent from the discussion which follows.

With reference to FIGS. 2 and 3, slightly different embodiments of the invention are shown. With reference to FIG. 2, the fencing rail 30 has the same construction as the fencing rail 10 so as to include long sides 31 and short ends 32. Webs 33 bridge between the long sides 31.

A pair of conductive members 34 and 35 extend along the junction or corner between the respective long sides 31 and short sides 32. Each of the conductive members 34 and 35 is attached to the outer surface 36 of the rail 30 by an adhesive conductive medium 37.

In FIG. 2, the conductive members 34 and 35 are fully encased within the conductive medium 37, so that the conductive members 34 and 35 are slightly spaced from the outer surface 36 of the rail 30. Thus, the conductive members 34 and 35 have no contact with the outer surface 36 of the rail 30.

Referring to FIG. 3, the fencing rail 40 has the same structure as the fencing rail 30 insofar as it includes long sides 41, short sides 42 and webs 43.

The rail 40 further includes conductive members 44 and 45 encased within a conductive medium 47, but in FIG. 3, there is contact between the conductive members 44 and 45 and the outer surface 46. Thus, the conductive members 44 and 45 are not fully encased within the conductive medium 37, but rather, are partly encased.

The difference between the rails 30 and 40 of FIGS. 2 and 3 is that in the fencing rail 40, the conductive members 44 and 45 bear against the outer surface 46 of the rail 40 whereas in the rail 30, the conductive members 34 and 35 are slightly spaced from the outer surface 36.

As indicated previously, rails according to the invention might include a combination of the embodiments of FIGS. 2 and 3 as far as the position of the conductive members relative to the outer surface of the rails is concerned. This is particularly the case where the conductive members are fixed to the outer surface of the rail manually by the application of a malleable conductive medium, so in some parts of the fencing rail, the conductive members will be in contact with the outer surface of the rail, while in other parts the conductive members will be fully encased within the conductive medium and therefore be spaced from the outer surface of the rail.

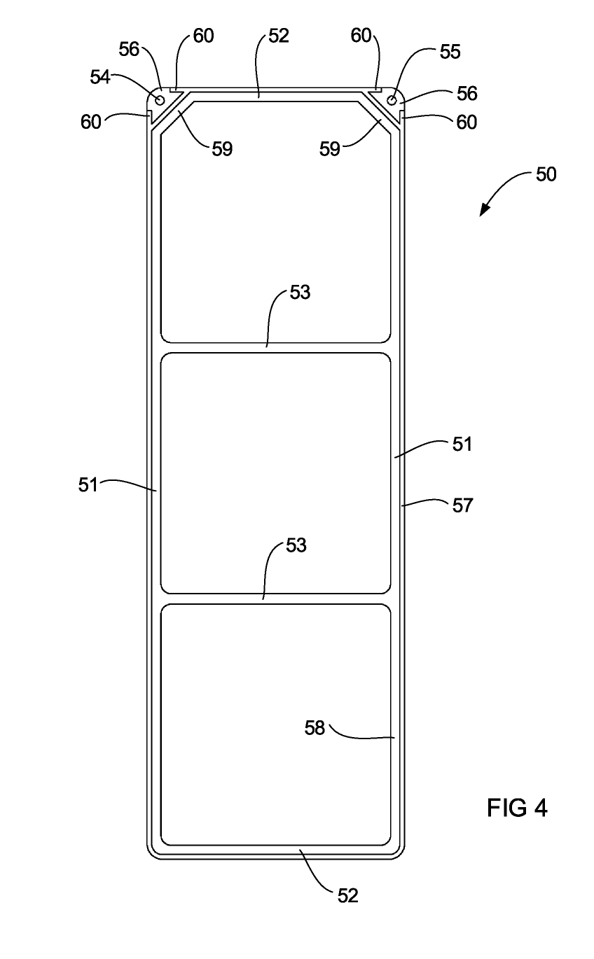

FIG. 4 depicts a further fencing rail 50, which includes long sides 51 and short ends 52. Webs 53 bridge between the long sides 51. A pair of conductive members 54 and 55 extend along the junction or corner between the respective long sides 51 and the short sides 52. Each of the conductive members 54 and 55 is a conductive wire, which is coated with a conductive polymer 56.

A 0.9 mm ASA capping layer 57 extends about a 1.8 mm PVC core 58.

It can be seem that the corners 59 at which the conductive members 54 and 55 are positioned are formed with a bevel or chamfer, or an incline, so the conductive polymer capping layer 57 can be fitted to or about the corners 59, but not to extend outwardly from the general rectangular formation of the fencing rail 50 like the embodiments shown in FIGS. 2 and 3.

It can be seem that at the corners 59, the conductive polymer 56 is formed to nest within a recess at each corner 59, whereby the recess is formed by lips or flanges 60. The lips or flanges 60 assist to maintain the conductive polymer 56 within the recesses at the corners 59, while the conductive polymer capping layer 57 also assists retention of the conductive polymer 56 within the recesses. In this example, the conductive polymer 56 could be malleable or flexible and be pushed into the recesses, or it could be rigid or stiff and either snapped into the recesses, or fed into the recesses from an end of a rail.

In the figures, the respective fencing rails 10, 30 and 40 can each include a thin substrate as described above (and as shown in FIG. 4) applied to the outer surface of the fencing rails. It should be appreciated however that the invention is intended to cover fencing rails which are formed solely from a plastic extrusion, as well as fencing rails that include a plastic extrusion and a thin substrate of the kind described above. The fencing rail 50 is shown with a thin ASA substrate applied to the outer surface of a PVC core.

The fencing rail of the invention is relatively lightweight compared to timber and metal fencing rails but has necessary strength and stiffness required for proper performance. Moreover, application of a substrate to the outer surface of the plastic extrusion can protect the plastic extrusion from deterioration and can allow the fencing rail to have a range of different surface finishes and colours. The fencing rail 10 is easy to cut and drill and will have a long life.

The invention described herein is susceptible to variations, modifications and/or additions other than those specifically described and it is to be understood that the invention includes all such variations, modifications and/or additions which fall within the spirit and scope of the present disclosure.

1. A fencing rail, including an elongate hollow plastic extrusion, which is generally rectangular in cross-section, the plastic extrusion has an outer surface and the fencing rail further including an elongate, electrically conductive member which is attached adjacent to the outer surface of the extrusion by a conductive medium which overlies the conductive member.

2. A fencing rail according to claim 1, the conductive member being a conductive wire.

3. A fencing rail according to claim 1, the conductive member being a flat strip that is square or rectangular in cross-section.

4. A fencing rail according to claim 1, the conductive member being a conductive plastic, thread or tape.

5. A fencing rail according to claim 1, the conductive medium being a conductive strip or tape that is applied over the conductive member and which adheres to the outer surface of the plastic extrusion.

6. A fencing rail according to claim 5, the conductive member being in touching contact with the outer surface of the plastic extrusion.

7. A fencing rail according to claim 1, the conductive medium being a pressure sensitive adhesive material.

8. A fencing rail according to claim 7, the pressure sensitive adhesive material being malleable.

9. A fencing rail according to claim 1, the conductive medium completely encasing the conductive member so that the conductive member is spaced from the outer surface of the plastic extrusion by a layer of conductive medium that is interposed between the member and the outer surface.

10. A fencing rail according to claim 1, the conductive medium being a conductive polymer or a high carbon content Acrylonitrile Styrene Acrylate.

11. A fencing rail according to claim 1, the plastic extrusion having in cross-section a pair of generally parallel long sides and a pair of generally parallel short ends and the conductive member is applied at the upper junction between a long side and a short end.

12. A fencing rail claim 1, the plastic extrusion having in cross-section a pair of generally parallel long sides and a pair of generally parallel short ends and a said conductive member is applied at each of the upper junctions between the long sides and the short ends

13. A fencing rail according to claim 1, the plastic extrusion having in cross-section a pair of generally parallel long sides and a pair of generally parallel short ends and the conductive member is applied to the or each of the long sides.

14. A fencing rail according to claim 1, the plastic extrusion having in cross-section a pair of generally parallel long sides and a pair of generally parallel short ends and a said conductive member is applied to the or each of the long sides.

15. A fencing rail according to claim 1, the plastic extrusion being formed from any one of PVC (polyvinylchloride), ASA (Acrylonitrile Styrene Acrylate), ABS (Acrylonitrile Butadiene Styrene), PMMA (Poly Methyl Methacrylate), HIPS (High Impact Styrene), PC (Poly Carbonate), PP (Polypropylene), PE (Polyethylene), Nylon, WPC (Wood Plastic Composite), SAN (Styrene and Acrylonitrile).

16. A fencing rail according to claim 1, further including a thin substrate which is applied to substantially the full outer surface of the extrusion to form an outer skin.

17. A fencing rail according to claim 16, the substrate being formed from ASA (Acrylonitrile Styrene Acrylate), ABS (Acrylonitrile Butadiene Styrene), PMMA (Poly Methyl Methacrylate), Nylon, SAN (Styrene and Acrylonitrile) or Polycarbonate

18. A fencing rail according to claim 1, the plastic extrusion having a pair of generally parallel long sides and a pair of generally parallel short ends defining the generally rectangular cross-section and defining an interior between the sides and ends, the plastic extrusion including a web extending across the interior from one of the pair of long sides to the other of the pair of long sides.

19. A fencing rail according to claim 18, the web extending substantially parallel to the short ends.

20. A fencing rail according to claim 18, the plastic extrusion including a pair of webs extending across the interior from one of the pair of long sides to the other of the pair of long sides, the webs being spaced apart.
